(19) United States
(12) Patent Application Publication
(10) Pub. No.: US 2019/0303322 A1
(43) Pub. Date: Oct. 3, 2019

(54) DIRECT INTERRUPT ROUTING FOR DISPLAY PROCESSING

(71) Applicant: QUALCOMM Incorporated, San Diego, CA (US)

(72) Inventors: Deepak Sharma, Hyderabad (IN); Sandeep Karajgaonkar, Hyderabad (IN); Babu Chitturi, Hyderabad (IN); Mohammed Ayub Khan, Mahbubnagar (IN)

(21) Appl. No.: 15/940,493

(22) Filed: Mar. 29, 2018

(51) Int. Cl. G06F 13/24; G06F 9/4401; G06F 3/048

(52) U.S. Cl. CPC G06F 13/24; G06F 3/048; G06F 9/4418

(57) ABSTRACT

A method of display processing comprising receiving a request to turn on a display panel from an inactive state, sending a first interrupt to a processor executing an operating system, sending a second interrupt to a display sub-system in parallel with the first interrupt, generating a first image for display in response to the first interrupt, and configuring the display sub-system in response to the second interrupt, wherein configuring the display sub-system is performed in parallel with generating the image.

### TECHNICAL FIELD

The disclosure relates to display processing.

### BACKGROUND

The speed at which a device renders images for display (e.g., a graphical user interface) is one aspect by which user experience is judged. It is generally preferable for a device to display image content as quickly as possible when being activated from an inactive state (i.e., any state where the display of a device is off). Inactive states may include states where the device is powered off or states when the device is in a sleep/rest mode. Mobile devices enter sleep/rest modes often to maintain battery life. Accordingly, there are many situations where the device, including any display sub-systems, are configured (e.g., configured from an off or inactive state to an active state) prior to displaying image content.

### SUMMARY

In general, this disclosure describes techniques for configuring a display sub-system when activating a device including the display sub-system to transition from an inactive state to an active state. An inactive state may be any state of the apparatus where a display panel of the display sub-system is off. For example, the inactive state may be a sleep/rest state where the apparatus is powered on, but the display panel is not displaying any images. In other examples, an inactive state may be a state where the display sub-system displays a static image. In other examples, the inactive state may be when the device is powered off.

This disclosure describes techniques where a user (e.g., through interaction with the user interface of a device) requests that a device be activated from an inactive state. This disclosure describes the generation of two interrupts in response to the activation request. One interrupt may be sent to a processor executing the operating system. The processor may perform any wake-up and/or power-on procedure in response to the interrupt and cause an image to be rendered for display (e.g., an image for a graphical user interface).

In parallel with the first interrupt, the device may further generate a second interrupt that is sent, in parallel with the first interrupt, to the display sub-system (e.g., a display processor and/or display panel). The display sub-system may configure itself for active operation and power-on the display panel in response to the second interrupt. In this way, rather than waiting for the image to be rendered (e.g., by a graphics processing unit) to start display sub-system configuration and power-on, the display sub-system may be configured in parallel with graphical user interface rendering. As such, the display sub-system may be ready to display the rendered image in a shorter amount of time relative to the rendering of the image. In some examples, the display sub-system may be ready to display an image before the image of the graphical user interface is rendered. In such situations, the display sub-system may display a default image until the graphical user interface is rendered.

In one example of the disclosure, a method of display processing comprises receiving a request to turn on a display panel from an inactive state, sending a first interrupt to a processor executing an operating system in response to the request, sending a second interrupt to a display sub-system in parallel with the first interrupt in response to the request, generating a first image for display in response to the first interrupt, and configuring the display sub-system in response to the second interrupt, wherein configuring the display sub-system is performed in parallel with generating the image.

In another example of the disclosure, an apparatus configured for display processing comprises a processor, a display sub-system and a user interface controller, wherein the user interface controller is configured to receive a request to turn on a display panel from an inactive state, send a first interrupt to the processor executing an operating system in response to the request, send a second interrupt to the display sub-system in parallel with the first interrupt in response to the request, wherein the processor is configured to generate a first image for display in response to the first interrupt; and wherein the display sub-system is configured to configure the display sub-system in response to the second interrupt, wherein configuring the display sub-system is performed in parallel with generating the image.

In another example of the disclosure, an apparatus configured for display processing comprises means for receiving a request to turn on a display panel from an inactive state, means for sending a first interrupt to a processor executing an operating system in response to the request, means for sending a second interrupt to a display sub-system in parallel with the first interrupt in response to the request, means for generating a first image for display in response to the first interrupt, and means for configuring the display sub-system in response to the second interrupt, wherein configuring the display sub-system is performed in parallel with generating the image.

In another example, this disclosure describes a computer-readable storage medium storing instructions that, when executed, causes one or more processors to receive a request to turn on a display panel from an inactive state, send a first interrupt to a processor executing an operating system in response to the request, send a second interrupt to a display sub-system in parallel with the first interrupt in response to the request, generate a first image for display in response to the first interrupt, and configure the display sub-system in response to the second interrupt, wherein configuring the display sub-system is performed in parallel with generating the image.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram of a device configured to perform one or more of the example techniques described in this disclosure.

FIG. 2 is a conceptual diagram illustrating an example of direct interrupt routing for a sleep/rest mode.

FIG. 3 is a flowchart illustrating an example method of direct interrupt routing for a sleep/rest mode.

FIG. 4 is a conceptual diagram illustrating an example of direct interrupt routing for a power-off mode.

FIG. 5 is a flowchart illustrating an example method of direct interrupt routing for a power-off mode.

FIG. 6 is a flowchart illustrating an example method of operation according to one or more example techniques described in this disclosure.

### DETAILED DESCRIPTION

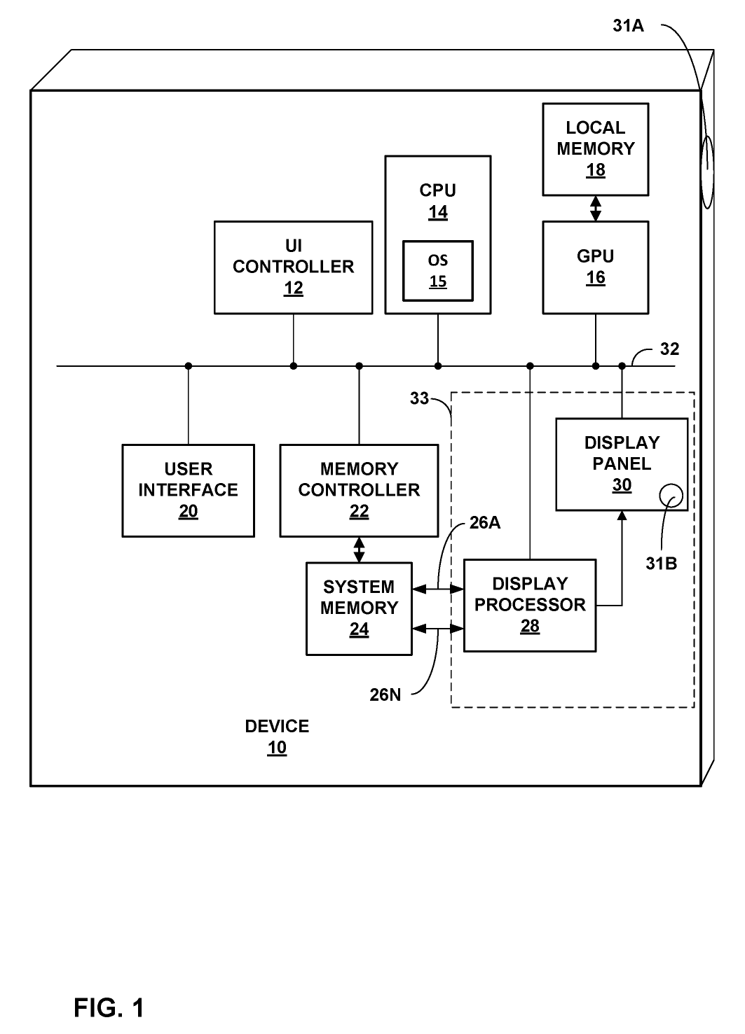

FIG. 1 is a block diagram illustrating an example device for performing display processing techniques in accordance with one or more examples described in this disclosure. FIG. 1 illustrates device 10, examples of which include, but are not limited to, video devices such as media players, set-top boxes, wireless handsets such as mobile telephones (e.g., so-called smartphones), personal digital assistants (PDAs), desktop computers, laptop computers, gaming consoles, video conferencing units, tablet computing devices, and the like.

In the example of FIG. 1, device 10 includes user interface (UI) controller 12, central processing unit (CPU) 14, graphics processing unit (GPU) 14, local memory 18, user interface 20, memory controller 22, system memory 24, one or more pipes 26A-26N (collectively pipes 26), display panel 30, pressure sensor 31A, and bus 32. Although one pressure sensor 31A is illustrated on the side of device 10, in some examples, there may be a plurality of pressure sensors located on device 10, such as on the side of, or flush with device 10.

Display panel 30 may also include pressure sensor 31B. Pressure sensor 31B is shown to assist with understanding that display panel 30 may generate output signals indicative of duration and pressure of user interaction with display panel 30. Pressure sensor 31B need not be located at the illustrated location in display panel 30. Display panel 30 may include a plurality of pressure sensors arranged on display panel 30.

In examples where device 10 is a mobile device, display processor 28 may be a mobile display processor (MDP). In some examples, such as examples where device 10 is a mobile device, UI controller 12, CPU 14, GPU 16, and display processor 28 may be formed as an integrated circuit (IC). For example, the IC may be considered as a processing circuit within a chip package, and may be a system-on-chip (SoC). In some examples, UI controller 12 may be in one housing, and CPU 14, GPU 16, and display processor 28 may be housed together in another IC. It may be possible that UI controller 12, CPU 14, GPU 16, and display processor 28 are all housed in different integrated circuits in examples where device 10 is a mobile device. Other permutations and combinations of the housing of UI controller 12, CPU 14, GPU 16, and display processor 28 are possible.

Examples of UI controller 12, CPU 14, GPU 16, and display processor 28 include, but are not limited to, one or more digital signal processors (DSPs), general purpose microprocessors, application specific integrated circuits (ASICs), field programmable logic arrays (FPGAs), or other equivalent integrated or discrete logic circuitry. In some examples, GPU 16 and display processor 28 may be specialized hardware that includes integrated and/or discrete logic circuitry that provides GPU 16 and display processor 28 their processing capabilities. For instance, display processor 28 may be specialized integrated circuit hardware that is designed to retrieve image content from system memory 24, compose the image content into an image frame, and output the image frame to display panel 30.

In general, CPU 14, GPU 16, and display processor 28 are examples of processing circuits configured to perform the example techniques described in this disclosure. The processing circuit includes fixed-function processing circuitry and/or programmable processing circuitry. Accordingly, the example techniques may be performed with fixed-function processing circuitry, programmable processing circuitry, or a combination of fixed-function and programmable processing circuitry, any of which may be referred to as one or more processors.

The various units illustrated in FIG. 1 communicate with each other using bus 32. Bus 32 may be any of a variety of bus structures, such as a third-generation bus (e.g., a HyperTransport bus or an InfiniBand bus), a second-generation bus (e.g., an Advanced Graphics Port bus, a Peripheral Component Interconnect (PCI) Express bus, or an Advanced eXtensible Interface (AXI) bus) or another type of bus or device interconnect. It should be noted that the specific configuration of buses and communication interfaces between the different components shown in FIG. 1 is merely exemplary, and other configurations of computing devices and/or other image processing systems with the same or different components may be used to implement the techniques of this disclosure.

Device 10 may also include display panel 30 and user interface 20. Although not illustrated, device 10 may include a transceiver module. Device 10 may include additional modules or units not shown in FIG. 1 for purposes of clarity. For example, device 10 may include a speaker and a microphone, neither of which are shown in FIG. 1, to effectuate telephonic communications and/or permit audio recording and playback in examples where device 10 is a mobile wireless telephone. Furthermore, the various modules and units shown in device 10 may not be necessary in every example of device 10. For example, user interface 20 and display panel 30 may be external to device 10 in examples where device 10 is a desktop computer. As another example, user interface 20 may be part of display panel 30 in examples where display panel 30 is a touch-sensitive or presence-sensitive display of a mobile device.

Display panel 30 may comprise a liquid crystal display (LCD), a plasma display, a touch-sensitive display (touchscreen), a presence-sensitive display, or another type of display device. User interface 20 is used in this disclosure to generically refer to ways in which a user may interface with device 10. Examples of user interface 20 include, but are not limited to, a power button, a home button, a volume button, a fingerprint sensor, a trackball, a mouse, a keyboard, and other types of input devices. User interface 20 may also be a touch screen and may be incorporated as a part of display panel 30. Although shown separately, pressure sensors 31A, 31B may be considered as examples of user interface 20. The transceiver module (not shown) of device 10 may include circuitry to allow wireless or wired communication between device 10 and another device or a network. The transceiver module may include modulators, demodulators, amplifiers and other such circuitry for wired or wireless communication.

Memory controller 22 facilitates the transfer of data going into and out of system memory 24. For example, memory controller 22 may receive memory read and write commands, and service such commands with respect to memory 24 to provide memory services for the components in computing device 10. Memory controller 22 is communicatively coupled to system memory 24. Although memory controller 22 is illustrated in the example of device 10 of FIG. 1 as being a processing circuit that is separate from both CPU 14 and system memory 24, in other examples, some or all of the functionality of memory controller 22 may be implemented on one or both of CPU 14 and system memory 24.

System memory 24 may store program modules and/or instructions and/or data that are accessible by CPU 14 and GPU 16. For example, system memory 24 may store user applications (e.g., instructions for the camera application), resulting images from GPU 16, etc. System memory 24 may additionally store information for use by and/or generated by other components of device 10. System memory 24 may include one or more volatile or non-volatile memories or storage devices, such as, for example, random access memory (RAM), double data rate (DDR) RAM, static RAM (SRAM), dynamic RAM (DRAM), read-only memory (ROM), erasable programmable ROM (EPROM), electrically erasable programmable ROM (EEPROM), flash memory, a magnetic data media or an optical storage media.

In some examples, system memory 24 may include instructions that cause CPU 14, GPU 16, and display processor 28 to perform the functions ascribed to these components in this disclosure. Accordingly, system memory 24 may be a computer-readable storage medium having instructions stored thereon that, when executed, cause one or more processors (e.g., CPU 14, GPU 16, and display processor 28) to perform various functions.

In some examples, system memory 24 is a non-transitory storage medium. The term “non-transitory” indicates that the storage medium is not embodied in a carrier wave or a propagated signal. However, the term “non-transitory” should not be interpreted to mean that system memory 24 is non-movable or that its contents are static. As one example, system memory 24 may be removed from computing device 10, and moved to another device. As another example, memory, substantially similar to system memory 24, may be inserted into computing device 10. In certain examples, a non-transitory storage medium may store data that can, over time, change (e.g., in RAM).

CPU 14 may execute various types of applications. Examples of the applications include web browsers, e-mail applications, spreadsheets, video games, or other applications that generate viewable objects for display. In examples of this disclosure, CPU 14 may also be configured to execute operating system (OS) 15. Operating system 15 is a program that serves as the framework for controlling the operation of other applications and hardware in device 10. In examples of this disclosure, CPU 14 may execute OS 15 to cause GPU 16 to render images for display on display panel 15. An example image may be a graphical user interface through which a user may control the operation of device 10 (e.g., through a touchscreen on display panel 30).

System memory 24 may store instructions for execution of the one or more applications and OS 15. The execution of an application on CPU 14 causes CPU 14 to produce graphics data for image content that is to be displayed. CPU 14 may transmit graphics data of the image content to GPU 16, e.g., via bus 32, for further processing based on and instructions or commands that CPU 14 transmits to GPU 16.

CPU 14 may communicate with GPU 16 in accordance with a particular application processing interface (API). Examples of such APIs include the DirectX® API by Microsoft®, the OpenGL® or OpenGL ES®by the Khronos group, and the OpenCL™; however, aspects of this disclosure are not limited to the DirectX, the OpenGL, or the OpenCL APIs, and may be extended to other types of APIs. Moreover, the techniques described in this disclosure are not required to function in accordance with an API, and CPU 14 and GPU 16 may utilize any technique for communication.

In accordance with the example techniques described in this disclosure, display processor 28 may be configured to composite the various image content rendered by GPU 16 and/or CPU 14 that is stored in system memory 24 for display on display panel 30. For instance, in addition to communication via bus 32, display processor 28 may be coupled to system memory 24 via a plurality of pipes 26. Display processor 28 may be configured to retrieve the image content from different applications executing on CPU 14 or image content rendered by GPU 16, or image content stored in system memory 24, via pipes 26. Display processor 28 and display panel 30 may be referred to, collectively, as display sub-system 33.

As an example, CPU 14 may execute a plurality of applications that each generate image content. For instance, CPU 14 may execute a video player application that uses a hardware or software video decoder (not shown) to generate video content that is stored in system memory 24. As another example, CPU 14 may execute a web browser that produces text content that is stored in system memory 24. Furthermore, GPU 16 may render one or more images that form part of a graphical user interface.

In accordance with techniques of this disclosure, generating an image or image content for display may include any technique that CPU 14, GPU 16, or another hardware unit of device may use to produce an image to be displayed on display panel 30. In one example, generating an image for display may include GPU 16 rendering an image for display. In another example, generating an image for display may include CPU 14 rendering an image for display. In another example, generating an image for display may include CPU 14 compositing two or more images stored in memory. In another example, generating an image for display may include GPU 16 rendering an image using ray tracing techniques. In another example, generating an image for display may include a video decoder decoding encoded video data to produce a frame of video data. In another example, generating an image of display may include CPU 16 fetching an image from memory. As should be understood, device 10 may use any technique for generating an image.

Display processor 28 retrieves the image content, via pipes 26, and composites one single frame for display. For example, image content from one application may occlude image content from another application, and display processor 28 may ensure that the image content that is occluded does not interfere with the image content that is occluding. In general, compositing means that display processor 28 stitches image content from different applications into a single frame. Display processor 28 may perform additional functions, such as filtering, stretching, zooming, rotating, and scaling.

Display processor 28 generates image signals that display processor 28 outputs to display panel 30 that cause display panel 30 to display the image content. In this way, display panel 30 may be configured to display the image content generated by the various applications to a user.

In many cases, the image content from the applications is not static and is changing. Accordingly, display processor 28 periodically refreshes the image content displayed on display panel 30. For example, display processor 28 periodically retrieves image content from system memory 24, where the image content may have been updated by the execution of the applications, and outputs image signals to display panel 30 to display the updated image content.

Display panel 30 may be configured in accordance with the MIPI DSI (Mobile Industry Processor Interface, Display Serial Interface) standard. The MIPI DSI standard supports a video mode and command mode. In examples where display panel 30 is a video mode panel, display processor 28 may need to constantly refresh display panel 30 and display panel 30 does not need or include a frame buffer. In examples where display panel 30 is a video mode panel, the entire image content is refreshed per refresh cycle (e.g., line-by-line). In examples where display panel 30 is a command mode panel, display panel 30 includes a frame buffer to which display processor 28 writes the image content of the frame. Display processor 28 then writes from the frame buffer to display panel 30. In such examples where display panel 30 is a command mode panel, display processor 28 may not need to refresh display panel 30 constantly.

In some example computing devices, including mobile phones and tablets, there is typically a time delay involved between requesting an activation of an inactive display (e.g., the display is not displaying an image) and the display actually being active to show information (e.g., an image comprising the graphical user interface of the device). A display may be inactive because the device is completely powered off or because the device is in a sleep/rest mode. A sleep/rest mode may be any mode where a device is powered on, but the display is not displaying any information. In other examples, a sleep/rest mode may be any mode where a device is powered on, but the display is configured to display a static image or very infrequently updated image (e.g., in so-called always-on displays). A request to activate a display may occur when initiating a power-on of the device (e.g., pressing a power button) or any other activation technique that wakes up a device from a sleep/rest mode (e.g., pressing a power button, a home button, a volume button, a screen lock button, a fingerprint sensor, and/or making a gesture on a touchscreen of a display).

The latency between a request for display activation and the actual display of information may be due to multiple components of the device waking up, powering on, and/or performing configuration operations in a certain order. For example, for an activation request received while the device is in a sleep/rest mode, the device may perform the following steps in order:

1. The application processor (e.g., CPU 14) is in a sleep state and takes time to complete a wake-up process upon power-on.
2. A wake-up event is sent to the user interface/operating system framework (e.g., OS 15).
3. A displayable graphical user interface is rendered and composited (e.g., by GPU 16).
4. The display sub-system (e.g., display processor 28) is configured and a display panel power-on sequence is performed.

These processes are typically performed serially. Display sub-system configuration and display panel power-on can alone take 100 milliseconds (ms) or more. Accordingly, one source of poor user experience is due to delayed response in a display presenting information to user after a wake-up request.

Activating an inactive display from a power off condition may take even longer for information to be displayed. For an activation request received while the device is in a power-off mode, the device may perform the following steps in order:

1. An application processor (e.g., CPU 14) is powered up.
2. Other subsystems (e.g., buses, clocks, and memories) may also be powered up.
3. A wake-up event is sent to the user interface/operating system framework (e.g., OS 15).
4. A displayable graphical user interface is rendered and composited (e.g., by GPU 16).
5. The display sub-system (e.g., display processor 28) is configured and a display panel power-on sequence is performed.

Like the sleep mode example, all of the above steps are typically performed sequentially. The entire process may take 250 ms or more.

To limit the impact of this time, this disclosure proposes to perform the configuration of display sub-system 33 and/or the power-on of display panel 30 in parallel with the other processes described above (e.g., in parallel with CPU 14 wake-up, wake-up event at OS 15, image rendering by GPU 16, etc.). Such parallelism may be achieved by having a dedicated interrupt going to the display sub-system 33 and/or display panel 30 upon receiving a request for display activation.

Upon receiving the interrupt, the display pipeline may be configured and kept in standby until the composed frame (e.g., the UI) is generated by the UI/OS framework to be displayed. Display panel power-on involves providing a reset pulse and sending specific commands to the display panel. Upon the parallel power-on, and prior to receiving a frame to display, the display panel may be configured to display some generic scene. For example, a generic panel behavior may be to display black pixels on power-on. As soon as the UI/OS frame is generated and ready to be displayed, the display pipeline and display panel will be configured and powered on, and the display panel will be able to display the UI almost instantaneously.

In accordance with the above example, device 10 may be configured to receive a request to turn on display panel 30 from an inactive state, send a first interrupt to CPU 16 in response to receiving the request to turn on the display panel 30, send a second interrupt to a display sub-system 33 in parallel with the first interrupt, generate a first image (e.g., a graphical user interface) for display in response to the first interrupt, and configure display sub-system 33 in response to the second interrupt, wherein configuring display sub-system 33 is performed in parallel with generating the image.

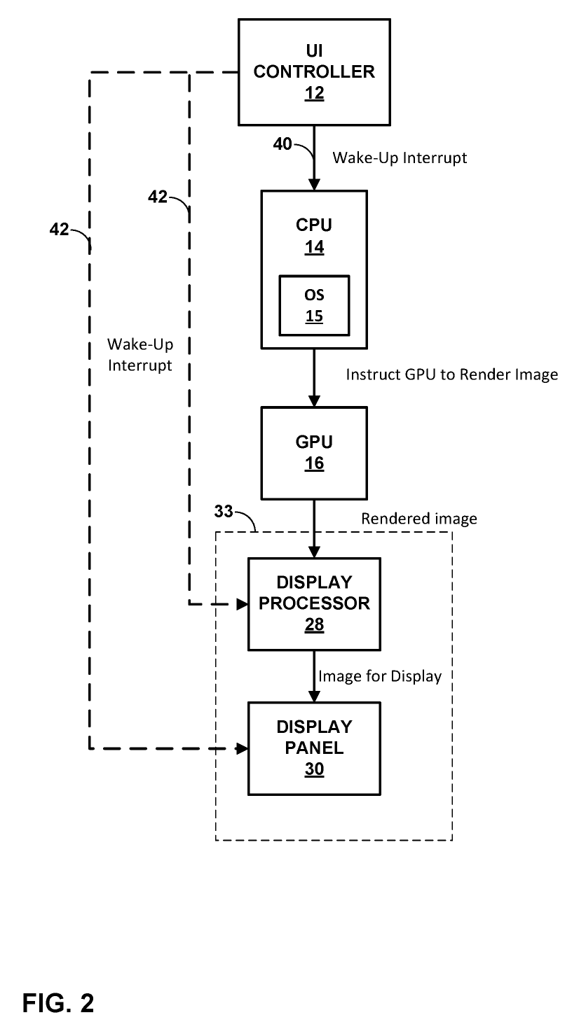

FIG. 2 is a conceptual diagram illustrating an example of direct interrupt routing for a sleep/rest mode. As shown in FIG. 2, UI controller 12 may receive a request to turn on display panel 30 when device 10 is in a sleep/rest mode. The sleep/rest mode may be any mode of operation where device 10 is still powered on, but display panel 30 is not displaying any information. In other examples, a sleep/rest mode may be any mode where a device is powered on, but the display is configured to display a static image or very infrequently updated image (e.g., in so-called always-on displays). The request for activation of display panel 30 may be received from any aspect of user interface 20, including user inputs from a power button, a home button, a volume button, a fingerprint sensor, or display panel touchscreen. In other examples, a request for display activation may occur automatically from one or more software and/or hardware functions operating on device 10 (e.g., a timer, position sensor, motion sensor, etc.). In other examples, device 10 may receive a request for activation of the display from some external source.

Regardless of how UI controller 12 receives the request for activation of the display, UI controller 12 may be configured to generate a wake-up interrupt 40 (e.g., a first interrupt) that is sent to CPU 14. In addition, UI controller 12 may be further configured to generate one or more wake-up interrupts 42 (e.g., a second interrupt) that are sent to display sub-system 33. In some examples, the second interrupt is different than the first interrupt. In other examples, the first and second interrupts are the same interrupt, but are routed to CPU 14 and display sub-system 33 over different paths so that they arrive at approximately the same time (i.e., the interrupts arrive in parallel).

Wake-up interrupt 40 may be received by CPU 14 and cause CPU 14 to perform configuration operations (e.g., a wake-up process) that are to be performed when transitioning out of sleep/rest mode. Such a wake-up process may be initiated by phone calls, gestures, text messages, etc. CPU 14 may also send a wake-up event to the OS 15 in response to wake-up interrupt 40. In response to receiving the wake-up event, OS 15 may send instructions to GPU 16 to render an image for display. The image rendered by GPU 16 may be the graphical user interface of device 10.

In parallel with the above wake-up processes performed by CPU 14 and GPU 16, display sub-system 33 may perform its own wake-up process in parallel. In this way, display sub-system 33 may be ready to display any images rendered by GPU 16 more quickly than compared to the above-described serial wake-up processes. In one example, wake-up interrupt 42 may be sent to display processor 28. In response, to wake-up interrupt 42 display processor 28 may perform a wake-up process and then power-on display panel 30. In other example, wake-up interrupt 42 may be sent to display panel 30, and display panel 30 may be configured to execute any power-on processes in parallel with wake-up processes performed by CPU 14, GPU 16, and display processor 28. In other examples, wake-up interrupt 42 may be sent to both display processor 28 and display panel 30. In this example, display processor 28 and display panel 30 may perform any desired wake-up processes in parallel.

In some examples, the rendered image produced by GPU 16 is available to be displayed when display processor 28 is done performing any wake-up processes. In this case, display processor 28 may perform any additional image processing and send the image for display at display panel 30. However, in some examples, display sub-system 33 may be finished with all wake-up processes before GPU 16 is done rendering the image for display. In this example, display processor 28 may be configured to send some default image to display panel 30 for display until GPU 16 finishes rendering the image. The default image may be any image desired. In some examples, the default image may be stored in a memory accessible by display processor 28. In other examples, display processor 28 may be configured to generate the default image. As one example, the default image may be an image where all pixels are of the same color (e.g., all white pixels). Display processor 28 may be configured to generate a frame of all white pixels and send the frame to display panel 30 for display.

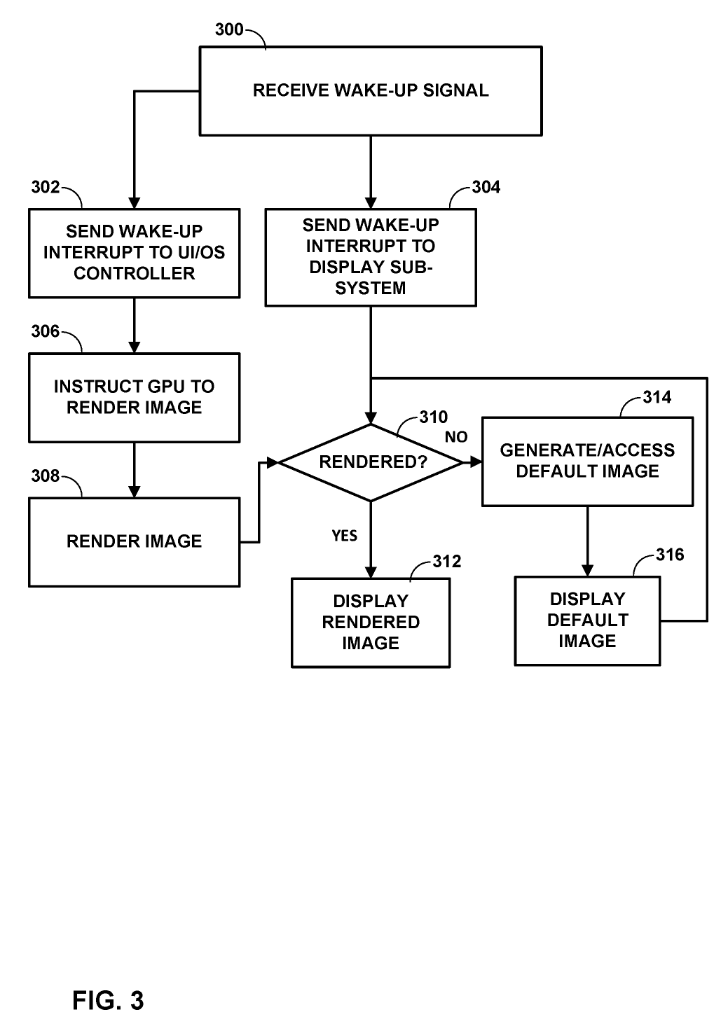

FIG. 3 is a flowchart illustrating an example method of direct interrupt routing for a sleep/rest mode. UI controller 12 may receive a wake-up signal and/or request for activation of the display (300). In response, UI controller 12 may send a wake-up interrupt to CPU 14 and OS 15 (302), as well as a wake-up interrupt to display sub-system 33 (304), e.g., in parallel with one another. The wake-up interrupts may be simultaneously or substantially simultaneously. CPU 14 may instruct GPU 16 to render an image (306), and GPU 16 may render the image (308).

In parallel with these processes, display sub-system 33 may perform the wake-up processes described above. After display sub-system 33 has completed the wake-up processes, display processor 28 may determine if GPU 16 has a rendered image available for display (310). If yes, display processor 28 will cause display panel 30 to display the rendered image (312). If no, display processor 28 may be configured to generate and/or access a default image (314). Display processor 28 may then cause display panel 30 to display the default image (316). Display processor 28 may then recheck if GPU 16 has finished rendering the image for display (310).

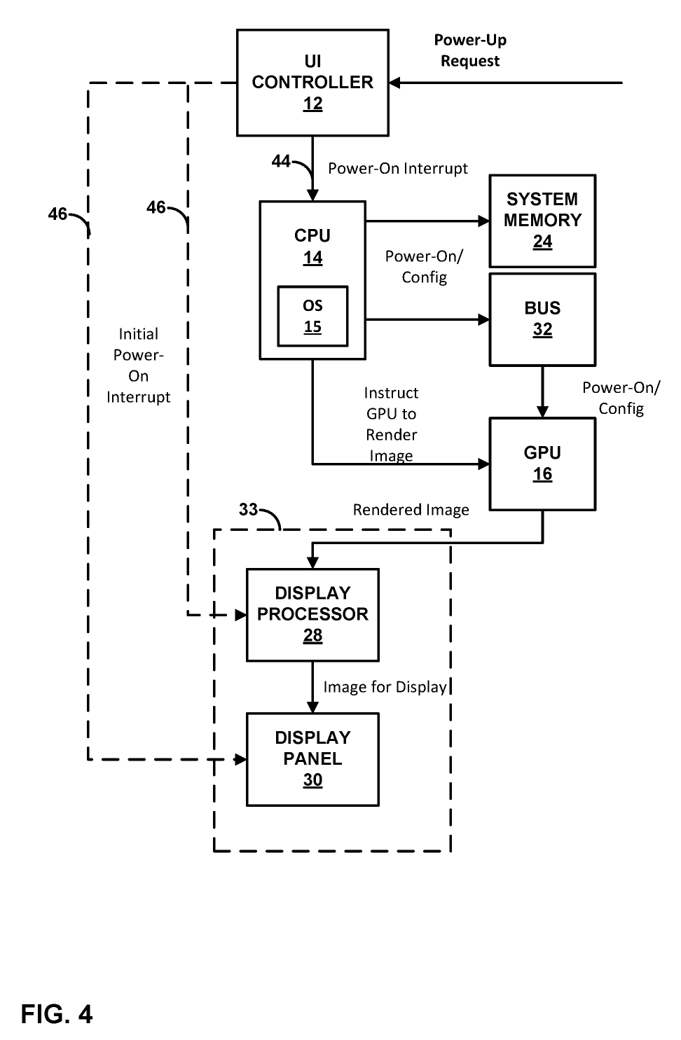

FIG. 4 is a conceptual diagram illustrating an example of direct interrupt routing for a power-off mode. In this mode device 10 is completely powered off. As shown in FIG. 4, UI controller 12 may receive a request to turn on device 10 when it is in a power-off mode. The request for powering on device 10 may be received from any aspect of user interface 20, including user inputs from a power button, a home button, a volume button, a fingerprint sensor, or display panel touchscreen. In other examples, a request for powering on device 10 may occur automatically from one or more software and/or hardware functions operating on device 10 (e.g., a timer, position sensor, motion sensor, etc.). In other examples, device 10 may receive a request for powering on device 10 from some external source.

Regardless of how UI controller 12 receives the request for powering on device 10, UI controller 12 may be configured to generate a power-on interrupt 44 (e.g., a first interrupt) that is sent to CPU 14. In addition, UI controller 12 may be further configured to generate one or more power-on interrupts 46 (e.g., a second interrupt) that are sent to display sub-system 33. In some examples, the second interrupt is different than the first interrupt. In other examples, the first and second interrupts are the same interrupt, but are routed to CPU 14 and display sub-system 33 over different paths so that they arrive at approximately the same time (i.e., the interrupts arrive in parallel).

Power-on interrupt 44 may be received by CPU 14 and cause CPU 14 to perform power-on configuration operations (e.g., a power-on process) that are to be performed when transitioning out powered-off mode. In response to power-on interrupt 40, CPU 14 may also cause various other hardware systems to engage in power-on and/or configuration processes, including system memory 24 and bus 32. CPU 14 may also send a power-on event to the OS 15 in response to power-on interrupt 44. In response to receiving the power-on event, OS 15 may send instructions to GPU 16 to render an image for display. The image rendered by GPU 16 may be an image representing the graphical user interface of device 10.

In parallel with the above power-on processes performed by CPU 14 and GPU 16, display sub-system 33 may perform its own power-on process in parallel. In this way, display sub-system 33 may be ready to display any images rendered by GPU 16 more quickly than compared to the above-described serial power-on processes. In one example, power-on interrupt 46 may be sent to display processor 28. In response, display processor 28 may perform a power-on process and then power-on display panel 30. In another example, power-on interrupt 46 may be sent to display panel 30, and display panel 30 may be configured to execute any power-on processes in parallel with power-on processes performed by CPU 14, GPU 16, and display processor 28. In other examples, power-on interrupt 46 may be sent to both display processor 28 and display panel 30. In this example, display processor 28 and display panel 30 may perform any desired power-on processes in parallel. In this context, in parallel may refer to processes that are simultaneously, and/or substantially simultaneously. For example, the power-on process for CPU 14 and GPU 16 may take a longer or shorter amount of time than the power-on process for display subsystem 33.

In some examples, the rendered image produced by GPU 16 is available to be displayed when display processor 28 is done performing any power-on processes. In this case, display processor 28 may perform any additional image processing and send the rendered image for display at display panel 30. However, in some examples, display sub-system 33 may be finished with all power-on processes before GPU 16 is done rendering the image for display. In this example, display processor 28 may be configured to send some default image to display panel 30 for display until GPU 16 finishes rendering the image. The default image may be any image desired. In some examples, the default image may be stored in a memory accessible by display processor 28. In other examples, display processor 28 may be configured to generate the default image. As one example, the default image may be an image where all pixels are of the same color (e.g., all white pixels). Display processor 28 may be configured to generate a frame of all white pixels and send the frame to display panel 30 for display.

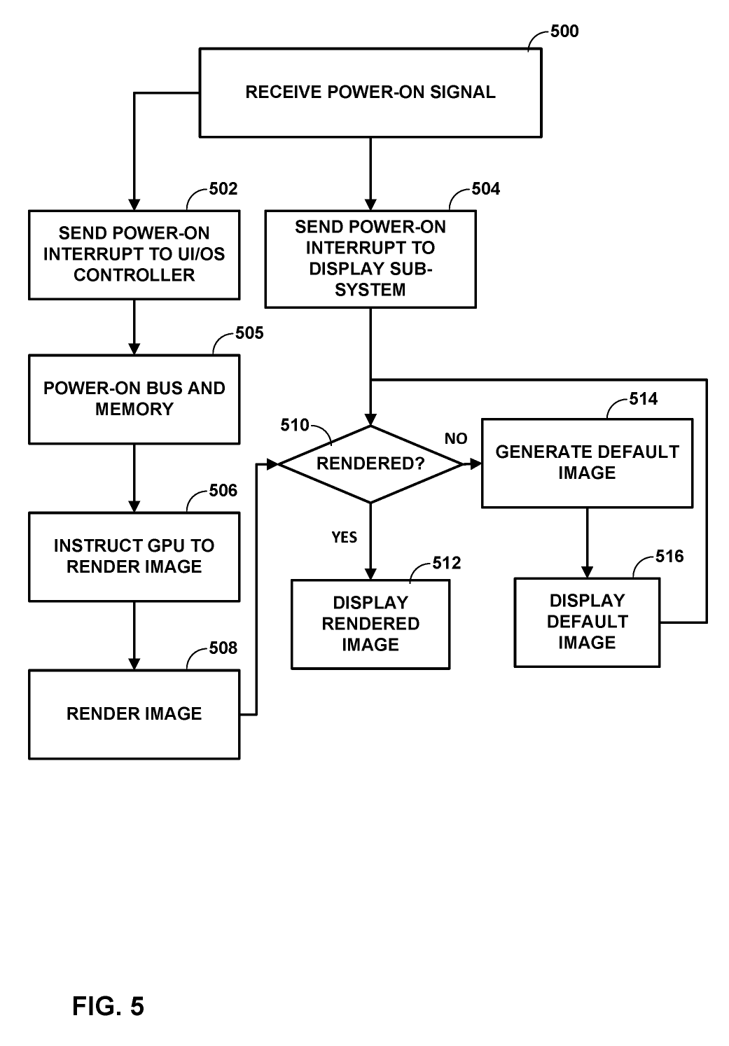

FIG. 5 is a flowchart illustrating an example method of direct interrupt routing for a power-off mode. UI controller 12 may receive a power-on signal and/or request for activation of the display (500). In response, UI controller 12 may send a power-on interrupt to CPU 14 and OS 15 (502), as well as a power-on interrupt to display sub-system 33 in parallel (504). CPU 14 may also be configured to power-on bus 32 and system memory 24 (505). CPU 14 may also instruct GPU 16 to rendering an image (506), and GPU 16 may render the image (508).

In parallel with these processes, display sub-system 33 may perform the power-on processes described above. After display sub-system 33 has completed the power-on processes, display processor 28 may determine if GPU 16 has a rendered image available for display (510). If yes, display processor 28 will cause display panel 30 to display the rendered image (512). If no, display processor 28 may be configured to generate and/or access a default image (514). Display processor 28 may then cause display panel 30 to display the default image (516). Display processor 28 may then recheck if GPU 16 has finished rendering the image for display (510).

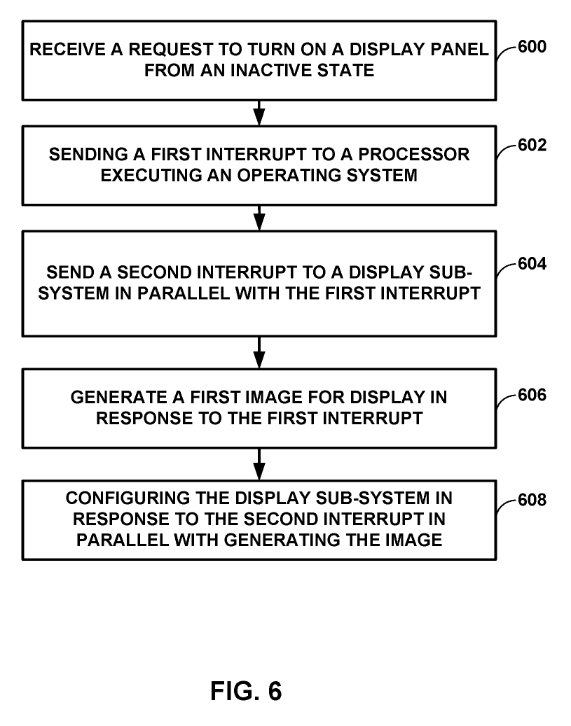

FIG. 6 is a flowchart illustrating an example method of operation according to one or more example techniques described in this disclosure. The techniques of FIG. 6 may be performed by one or more structural units of device 10 of FIG. 1, including UI controller 12, CPU 14, GPU 16, and/or display sub-system 33.

In one example of the disclosure, UI controller 12 may be configured to receive a request to turn on display panel 30 from an inactive state (600). The inactive state may be a powered-off state where a device is completely powered-off, or an inactive state where display panel 30 is off or infrequently updates. In some examples of the disclosure, receiving the request to turn on the display panel from the inactive state comprises receiving an indication that a power button (e.g., user interface 20) was activated. In other examples of the disclosure, receiving the request to turn on the display panel from the inactive state comprises receiving an indication that one or more of a power button, a home button, a volume button, a fingerprint sensor, or display panel touchscreen (e.g., user interface 20) was activated.

In response to receiving the request to turn on the display panel, UI controller may be further configured to send a first interrupt to a processor executing an operating system (602), and send a second interrupt to a display sub-system in parallel with the first interrupt (604).

CPU 14 may be configured to generate a first image for display in response to the first interrupt (606). In some example, CPU 14 may generate the first image for display by instructing GPU 16 to render the first image. In one example, the first image is a user interface image (e.g., an image for graphical user interface). Display sub-system 33 may be configured to configure display sub-system 33 in response to the second interrupt, wherein configuring display sub-system 33 is performed in parallel with generating the image (608). In one example, configuring display sub-system 33 comprises performing a power-on process at display panel 30 in response to the second interrupt. In another example, configuring display sub-system 33 comprises configuring display processor 28 in response to the second interrupt.

In some examples, display sub-system 33 may be configured to display a default image before the first image is generated. In some examples, the default image is stored in memory (e.g., system memory 24). In other examples, display sub-system 33 may be configured to generate the default image after configuring display sub-system 33.

In some examples, the inactive state is a sleep state. In this example, CPU 14 may be configured to perform a wake-up process in response to the first interrupt, send a wake-up event to OS 15 after performing the wake-up process at CPU 14, and send instructions to GPU 16 to generate the first image. GPU 16 may then render the first image. In other examples, the inactive state is an off state (e.g., the device is completely powered off). In this example, CPU 14 may be configured to perform a power-on process at CPU 14 in response to the first interrupt, perform a power-on process at one or memories, buses, and clocks, start execution of OS 15 after performing the power-on process at CPU 16, and send instructions to GPU 16 to generate the first image. GPU 16 may then render the first image.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some examples, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of display processing, the method comprising:
receiving a request to turn on a display panel from an inactive state;
sending a first interrupt to a processor executing an operating system in response to the request;
sending a second interrupt to a display sub-system in parallel with the first interrupt in response to the request;
generating a first image for display in response to the first interrupt; and
configuring the display sub-system in response to the second interrupt, wherein configuring the display sub-system is performed in parallel with generating the image.

2. The method of claim 1, further comprising:
displaying a default image before the first image is generated.

3. The method of claim 2, further comprising:
generating the default image after configuring the display sub-system.

4. The method of claim 1, wherein the first image is a user interface image.

5. The method of claim 1, wherein the inactive state is a sleep state, the method further comprising:
performing a wake-up process at the processor in response to the first interrupt;
sending a wake-up event to the operating system after performing the wake-up process at the processor;
sending instructions to a graphics processing unit to generate the first image; and
rendering, by the graphics processing unit, the first image.

6. The method of claim 1, wherein the inactive state is an off state, the method further comprising:
performing a power-on process at the processor in response to the first interrupt;
performing a power-on process at one or memories, buses, and clocks;
starting execution of the operating system after performing the power-on process at the processor;
sending instructions to a graphics processing unit to generate the first image; and
rendering, by the GPU, the first image.

7. The method of claim 1, wherein configuring the display sub-system comprises performing a power-on process at the display panel in response to the second interrupt.

8. The method of claim 1, wherein configuring the display sub-system comprises configuring a display processor in response to the second interrupt.

9. The method of claim 1, wherein receiving the request to turn on the display panel from the inactive state comprises receiving an indication that a power button was activated.

10. The method of claim 1, wherein receiving the request to turn on the display panel from the inactive state comprises receiving an indication that one or more of a power button, a home button, a volume button, a fingerprint sensor, or display panel touchscreen was activated.

11. An apparatus configured for display processing, the apparatus comprising:
a processor, a display sub-system and a user interface controller, wherein the user interface controller is configured to:
receive a request to turn on a display panel from an inactive state;
send a first interrupt to the processor executing an operating system in response to the request; and
send a second interrupt to the display sub-system in parallel with the first interrupt in response to the request;
wherein the processor is configured to:
generate a first image for display in response to the first interrupt; and
wherein the display sub-system is configured to:
configure the display sub-system in response to the second interrupt, wherein configuring the display sub-system is performed in parallel with generating the image.

12. The apparatus of claim 11, wherein the display sub-system includes the display panel, and the display panel is configured to display a default image before the first image is generated.

13. The apparatus of claim 12, wherein the display sub-system is further configured to generate the default image after configuring the display sub-system.

14. The apparatus of claim 11, wherein the first image is a user interface image.

15. The apparatus of claim 11, the apparatus further comprising a graphics processing unit, wherein the inactive state is a sleep state, and wherein the processor is further configured to:
perform a wake-up process at the processor in response to the first interrupt;
send a wake-up event to the operating system after performing the wake-up process at the processor; and
send instructions to the graphics processing unit to generate the first image; and
wherein the graphics processing unit is configured to:
render the first image.

16. The apparatus of claim 11, the apparatus further comprising a graphics processing unit, wherein the inactive state is an off state, and wherein the processor is further configured to:
perform a power-on process at the processor in response to the first interrupt;
perform a power-on process at one or memories, buses, and clocks;
start execution of the operating system after performing the power-on process at the processor;
send instructions to the graphics processing unit to generate the first image; and
wherein the graphics processing unit is configured to:
render the first image.

17. The apparatus of claim 11, wherein to configure the display sub-system, the display sub-system is configured to perform a power-on process at the display panel in response to the second interrupt.

18. The apparatus of claim 11, wherein to configure the display sub-system, the display sub-system is configured to configure a display processor in response to the second interrupt.

19. The apparatus of claim 11, wherein to receive the request to turn on the display panel from the inactive state, the user interface controller is configured to receive an indication that a power button was activated.

20. The apparatus of claim 11, wherein to receive the request to turn on the display panel from the inactive state, the user interface controller is configured to receive an indication that one or more of a power button, a home button, a volume button, a fingerprint sensor, or display panel touchscreen was activated.

21. The apparatus of claim 11, wherein the apparatus is a mobile telephone.

22. The apparatus of claim 11, wherein the apparatus is one of a laptop computer or a tablet computer.

23. An apparatus for display processing, the apparatus comprising:
means for receiving a request to turn on a display panel from an inactive state;
means for sending a first interrupt to a processor executing an operating system in response to the request;
means for sending a second interrupt to a display sub-system in parallel with the first interrupt in response to the request;
means for generating a first image for display in response to the first interrupt; and
means for configuring the display sub-system in response to the second interrupt, wherein configuring the display sub-system is performed in parallel with generating the image.

24. The apparatus of claim 23, further comprising:
means for displaying a default image before the first image is generated.

25. The apparatus of claim 24, further comprising:
means for generating the default image after configuring the display sub-system.

26. The apparatus of claim 23, wherein the first image is a user interface image.

27. A computer-readable storage medium storing instructions that, when executed, causes one or more processors to:
receive a request to turn on a display panel from an inactive state;
send a first interrupt to a processor executing an operating system in response to the request;
send a second interrupt to a display sub-system in parallel with the first interrupt in response to the request;
generate a first image for display in response to the first interrupt; and
configure the display sub-system in response to the second interrupt, wherein configuring the display sub-system is performed in parallel with generating the image.

28. The computer-readable storage medium of claim 27, wherein the instructions further cause the one or more processors to:
display a default image before the first image is generated.

29. The computer-readable storage medium of claim 28, wherein the instructions further cause the one or more processors to:
generate the default image after configuring the display sub-system.

30. The computer-readable storage medium of claim 27, wherein the first image is a user interface image.
